(19) United States
(12) Patent Application Publication
(10) Pub. No.: US 2006/0250372 A1
(43) Pub. Date: Nov. 9, 2006

(54) Touchpad with smart automatic scroll function and control method therefor

(76) Inventor: Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/274,134

(22) Filed: Nov. 16, 2005

(30) Foreign Application Priority Data
May 5, 2005 (TW) 094114513

(51) Int. Cl. G09G 5/00

(52) U.S. Cl. 345/173

(57) ABSTRACT

A touchpad is defined to have a first zone and a second zone, and operated in such a way that a location information of an object is generated when the object is detected to move within the first zone, and a scrolling signal is generated if the object moves into the second zone and stays therewithin for a period longer than a threshold time.

### FIELD OF THE INVENTION

The present invention is generally related to a touchpad, and, more particularly, to a touchpad with smart automatic scroll function and a control method therefor.

### BACKGROUND OF THE INVENTION

Touchpad has been widely used in various electronic products, including notebook computer, personal digital assistant (PDA), mobile phone and other electronic systems. Touchpad serves as an input device where users touch or slide on the operational zone of the touchpad by objects such as finger and pen, to control a cursor on a window in relative movement or absolute coordinate movement and to support other extended functions such as key or button simulation. For more versatile functions on the operational zone, partitioning of the operational zone is employed, together with detection methods to determine which function is desired for use.

Along with the progress in monitor and display card technologies, computers nowadays are usually able to support high resolution screen, for example 1024×768. However, touchpad is limited by its size, and therefore does not support such high resolution actually. To overcome this drawback, a smart edge function is proposed for touchpad, by which the cursor can move automatically when the user slides his finger to the pre-defined edge zone of the touchpad. As shown in FIG. 1, touchpad 10 is defined to have two zones 12 and 14, and the zone 14 occupies the edge of the touchpad 10. When user's finger 16 moves within the zone 12, the touchpad 10 will send out the location information of the finger 16 to control cursor 18 on a window in response to the movement of the finger 16. While the finger 16 moves into the zone 14, the touchpad 10 will send out a scrolling signal to control the cursor 18 to automatically move along the direction it was moving on. In regard to the smart edge function, readers may refer to U.S. Pat. No. 5,543,590 to Gillespie et al. for more detail operations.

However, such smart edge function is only able to send out scrolling signal with the cursor's moving direction once user's finger slides into the edge zone 14, but not able to judge if the user intends to operate with general cursor control or smart automatic scrolling. Therefore, wrong operations may occur frequently. For example, the user might intend to move the cursor 18 as the trace shown in FIG. 2, but unintentionally slides his finger 16 into the edge zone 14 during the movement, causing the touchpad 10 to send out a scrolling signal by the smart edge function, and the cursor 18 will move along the trace as shown in FIG. 3 instead.

Therefore, it is desired a touchpad able to distinguish general cursor function and automatic scroll function to overcome the above drawbacks.

### SUMMARY OF THE INVENTION

An object of the present invention is to propose a touchpad with smart automatic scroll function and a control method therefor, which can distinguish if a user intends to operate the touchpad with a general cursor function or an automatic scroll function.

According to the present invention, a touchpad with smart automatic scroll function comprises a first zone and a second zone, whose control method comprises first detecting the location of an object on the touchpad. If the object is detected to move within the first zone, the touchpad will send out the location information of the object. If the object is detected to move into the second zone and stay therewithin for a period longer than a threshold time, the touchpad will send out a scrolling signal. However, if the object stays within the second zone for a period shorter than the threshold time, the touchpad will still send out the location information of the object, including an absolute coordinate or relative movement amount. The scrolling signal may include the location information or a digital signal representing the touched zone, for example the right edge zone.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a normal operation of a finger on a touchpad;

FIG. 2 shows an unintentional operation of a finger on a touchpad;

FIG. 3 shows a wrong detection of an operation of a finger on a touchpad; and

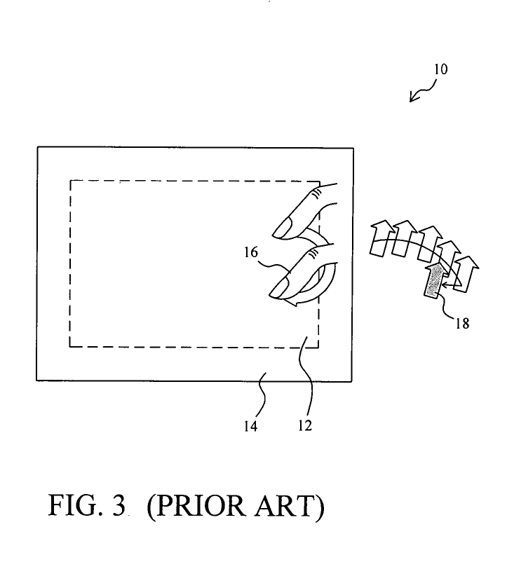

FIG. 4 shows a flowchart according to the present invention.

### DETAILED DESCRIPTION OF THE INVENTION

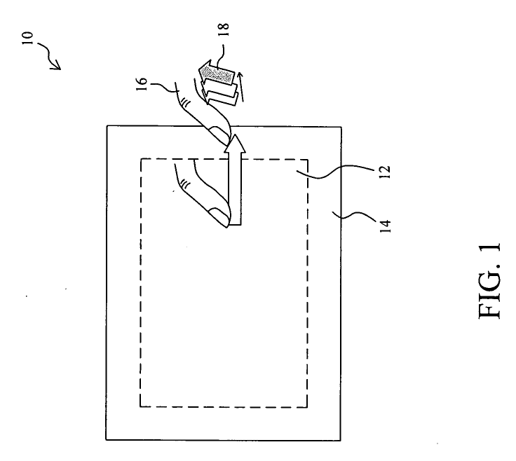

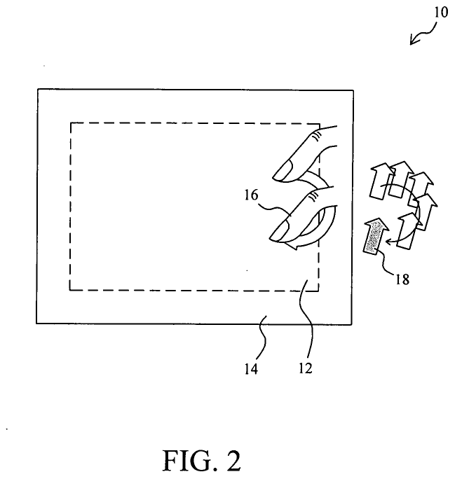

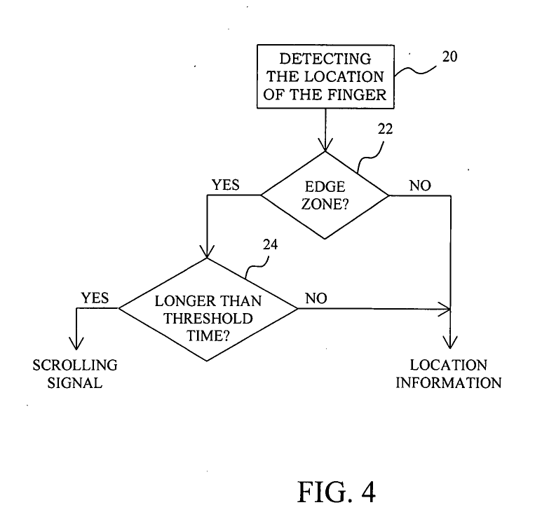

FIG. 4 shows a flowchart according to the present invention. Referring to FIGS. 1, 2 and 4, when the finger 16 moves on the touchpad 10, the touchpad 10 performs step 20 to detect the location of the finger 16, and then performs step 22 to judge if the finger 16 is within the edge zone 14 based on the detection of the step 20. If the finger 16 is not within the edge zone 14, the touchpad 10 will send out the location information of the finger 16 to control the cursor 18 to move along with the finger 16. On the contrary, if the finger 16 is within the edge zone 14, then step 24 is performed to count if the finger 16 stays within the edge zone 14 for a period lingerer than a threshold time. If the finger 16 did stay within the edge zone 14 longer than the threshold time, as shown in FIG. 1, the touchpad 10 will send out a scrolling signal for the cursor 18 to automatically move along the direction it was moving on. If the counted time is not up to the threshold time before the finger 16 slides out from the edge zone 14, as shown in FIG. 2, the touchpad 10 will still send out the location information of the finger 16 to control the cursor 18 to move along with the finger 16. In the operations, the location information may include absolute coordinate or relative movement amount, and the scrolling signal may include the location information or a digital signal representing the touched zone, for example the right edge zone.

In other embodiment, the touchpad may be defined to have two or more partition zones different from that shown in the above embodiments.

The present invention is applicable for touchpads having one-dimensional and two-dimensional sensing matrixes, to determine a general cursor function or an automatic scroll function by counting the time period of a finger or other object staying on specific zone or zones. As a result, not only versatile functions can be implemented for a touchpad, but also wrong operations are avoided.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A control method for a touchpad defined with a first zone and a second zone, the method comprising the steps of:
detecting a location of an object on the touchpad;
sending out a location information of the object during the object moves within the first zone; and
sending out a scrolling signal if the object moves into the second zone and stays therewithin for a period longer than a threshold time.

2. A touchpad comprising:
defined first and second zones;
wherein a location information of an object is generated when the object is detected to move within the first zone;
wherein a scrolling signal is generated if the object moves into the second zone and stays therewithin for a period longer than a threshold time.

3. The touchpad of claim 2, wherein the second zone comprises an edge zone.

4. The touchpad of claim 2, wherein the second zone surrounds the first zone.

5. The touchpad of claim 2, wherein the location information comprises an absolute coordinate.

6. The touchpad of claim 2, wherein the location information comprises a relative movement amount.

7. The touchpad of claim 2, wherein the scrolling signal comprises a digital signal.

8. The touchpad of claim 2, wherein the scrolling signal comprises a location information.
